(19) United States
(12) Patent Application Publication
(10) Pub. No.: US 2024/0184065 A1
(43) Pub. Date: Jun. 6, 2024

(54) OPTICAL FIBER CONNECTOR

(71) Applicant: FOX BIOSYSTEMS NV, Diepenbeek (BE)

(72) Inventors: Filip Delport, Diepenbeek (BE); Jens Jespers, Diepenbeek (BE)

(73) Assignee: FOX BIOSYSTEMS NV, Diepenbeek (BE)

(21) Appl. No.: 18/553,779

(22) PCT Filed: Apr. 6, 2022
(86) PCT No.: PCT/EP2022/059092

§ 371 Date: Oct. 3, 2023

(30) Foreign Application Priority Data
Apr. 8, 2021 (EP) 21167483.3

(51) Int. Cl. G02B 6/42; G02B 6/38

(52) U.S. Cl. CPC G02B 6/423; G02B 6/3803

(57) ABSTRACT

The present invention relates to an optical fiber connector to position and align an optical fiber into an analytical device, in particular into a bioanalytical device. Also a method for positioning and aligning an optical fiber in such a device is disclosed.

### FIELD OF THE INVENTION

The present invention relates to an optical fiber connector to position and align an optical fiber into an analytical device, in particular into a bioanalytical device. Also a method for positioning and aligning an optical fiber in such a device is disclosed.

### BACKGROUND TO THE INVENTION

Biosensors are analytical devices incorporating a biological sensing element. Biosensors are capable of detecting biomolecules in a complex sample by converting the physical or chemical signal to an optical signal or electrical signal which can further be processed to the concentration of the analyte. The components of said biosensors or bio-analytical devices include sensing unit, signal transducing and processing units. Biomolecules, i.e. antigen/antibody, enzymes, nucleic acids, hormone receptors, live cell and tissue, specifically recognize biological entities via catalysis and affinity binding.

Optical biosensors, for example used in surface plasmon resonance technology, have exhibited worthwhile performance in detecting biological systems and promoting significant advances in clinical diagnostics, drug discovery, food process control, and environmental monitoring. Without complexity in their pretreatment and probable influence on the nature of target molecules, these biosensors have additional advantages such as high sensitivity, robustness, reliability and potential to be integrated on a single chip.

Surface plasmon resonance (SPR) has emerged as the standard technology in biomolecular interaction analysis.

Surface plasmon resonance (SPR) has emerged as the standard technology in biomolecular interaction analysis. Next to the prism-based SPR system, fiber optic SPR (FO-SPR) forms an alternative platform, and offers numerous benefits such as remote sensing, continuous analysis and in situ monitoring using a small and inexpensive fiber based sensing element.

Fiber-optic SPR sensors present several advantages, such as a low cost and small size, high performances, a very low sample volume, remote sensing capabilities, portability and miniaturization. The small size of fiber-optic SPR sensors allows them to be incorporated into a multiple-fiber detection platform for the concurrent measurement of various components, such as different bio-chemical substances. In fact, efficient biosensors can be realized by immobilizing a biochemical receptor over the surface of an optical fiber SPR platform. For example, optical fibers are used as a probe which is inserted in a liquid sample available in e.g. a fluidic channel or shaken well.

Since the SPR signal is generated by irradiating light into a custom-made fiber optic SPR sensor, and said light has to enter to FO-SPR sensor under a critical angle, followed by capturing and processing of the refracted light signal in real-time, correct alignment and positioning of the optical fiber is crucial to avoid any artefacts during the analysis. To this end, optical fiber are placed in specific connectors for example by using a glue, specific clamps or other fixation means, such as for example shown in PCT publication WO2011/091408. The main problem here is that correct positioning and alignment remains challenging, and that in the bonding process excess of bonding material could affect the signaling across the optical fiber. With the present invention, an optical fiber connector is provided that ensures the correct positioning, alignment and fixation of an optical fiber into its connector and later on also into the (bio-) analytical device, without the need of a subsequent bonding process such as for example required in PCT publication WO2011/091408. Moreover, with the present invention, once the optical fiber is positioned and clamped in the optical fiber connector, the optical fiber cannot be moved or removed anymore without damaging the optical fiber connector.

### SUMMARY OF THE INVENTION

An object of the present application is to provide an optical fiber connector that allows the correct positioning, alignment and fixation of an optical fiber into an analytical device, in particular a bioanalytical device. The optical fiber connector of the present invention comprises an adaptor body (3) comprising a connector part (13) and an optical fiber alignment body (2) with a base component (5) and a mountable component (4). Typical for the present invention, the base component of the optical fiber alignment body and the adaptor body are single-pieced and the mountable component and the base component are configured to cooperate in positioning, alignment and fixation of the optical fiber such that the inner side of the base component and the inner side of the mountable component are oriented towards each other.

Thus, in a first aspect, the present invention provides an optical fiber connector comprising an adaptor body comprising an opening to receive an optical fiber and a connector part (13) being configured to be connected with a (bio-)analytical device, in particular the connection with the (bio-)analytical device can be made via a probe, biosensor mount, or biosensor manifold of an (bio)analytical device. The optical fiber connector also comprises an optical fiber alignment body, said body comprising a base component and a mountable component wherein said base component comprises an alignment groove in its inner side. The optical fiber connector is typically characterized in that the adaptor body and the base component of the optical fiber alignment body are single-pieced and that the mountable component and the base component are configured to cooperate not only in positioning and alignment of the optical fiber such that the inner side of the base component and the inner side of the mountable component are oriented towards each other, but also in fixation of the optical fiber in the optical fiber connector. As mentioned above, it is an object of the present invention to provide such fixation of the optical fiber without subsequent bonding process.

Thereto, according to a further feature of the optical fiber connector, the mountable component comprises one or more clamping means configured to cooperate with one or more recesses in the base component, and enabling a fixation of the optical in the optical fiber connector. In a further embodiment, the mountable component comprises at least two clamping means configured to cooperate with at least two recesses in the base component. In still another embodiment, the mountable component comprises two clamping means configured to cooperate with two recesses in the base component. In still another embodiment, the one or more clamping means are located on the longitudinal side of the mountable component, and they are configured to cooperate with one or more recesses in the longitudinal side of the base component. In another embodiment, the one or more clamping means are located in the central part of longitudinal side of the mountable component and they are configured to cooperate with one or more recesses in the central part of the longitudinal side of the base component. In another embodiment, the one or more clamping means are located in the central part and in both end parts of the longitudinal side of the mountable component and they are configured to cooperate with one or more recesses in the central part and in the end parts of the longitudinal side of the base component. In a preferred embodiment, two clamping means are located in the central part of the mountable component in each longitudinal side of the mountable component and they are configured to cooperate with two recesses in the central part of each longitudinal side of the base component.

According to another feature of an optical fiber connector according to the invention, the base component comprises one or more guiding means to guide the mounting of the mountable component on the base component. Said guiding means are located on the inner side of the base component. In a further embodiment, the base component comprises at least two guiding means, preferably two guiding means, on its inners side, to guide the mounting of the mountable component on the base component. In still a further aspect, the one or more guiding means are located on the inner side of the base component on each side of the alignment groove. In still another embodiment, the one or more guiding means are raised edges located on the inner side of the base component, in particular on each side of the alignment groove.

In another aspect of an optical fiber connector according to the invention, the mountable component of the optical fiber connector comprises on its inner side one or more protrusions configured to position, align and fix the optical fiber in the alignment groove of the base component and in the opening of the adaptor body. In a further embodiment, the mountable component comprises at least two of said protrusions. Said one or more protrusions can be located in the center part of the inner side of the mountable component; in particular wherein said one or more protrusions are positioned over the full length of the center part of the inner side of the mountable component. In another aspect, said one or more protrusions are located in the first and second end part of the inner side of the mountable component. In preferred embodiment, said protrusions are located in the first and second end part of the inner side of the mountable component; in particular one protrusion being located in the first end part and another protrusion being located in the second end part of the inner side of the mountable component. In another preferred embodiment, said protrusions are located in the first and second end part and in the central part of the inner side of the mountable component. For example, one protrusion being located in the first end part, another protrusion being located in the second end part and one or more protrusions being located in the central part of the inner side of the mountable component.

When present, and as mentioned herein before, the one or more protrusions of the mountable component are configured so that they fit on the optical fiber when the mountable component is placed on the base component comprising the optical fiber, and fix the optical fiber in the optical fiber connector. In a further embodiment, the one or more protrusions of the mountable component are hemispherical. In still another embodiment, the one or more protrusions of the mountable component have a beveled surface. In still a further embodiment, the one or more protrusions of the mountable component are hemispherical with a beveled surface. It has been found that such configuration wherein the protrusions have a beveled surface provides best grip on and fixation of the optical fiber without affecting the optical signaling across the optical fiber.

In another aspect of an optical fiber connector according to the invention, the mountable component of the optical fiber alignment body comprises a longitudinal recess on its inner side to receive the optical fiber when the mountable component is placed on the base component comprising the optical fiber. In a further embodiment, said longitudinal recess is present on the inner side of both end parts of the mountable component. In particular, said longitudinal recess comprises the one or more protrusions configured to position, align and fix the optical fiber in the optical fiber connector. In another embodiment, said longitudinal recess is present on the inner side of the full length of the mountable component.

According to another feature, the adaptor body of the optical fiber connector comprises a fiber receiving part, a flange part and a connector part, wherein the fiber receiving part comprises the opening to receive the optical fiber and wherein the connector part is configured to connect the optical fiber connector with the (bio)analytical device. In a further embodiment, the flange part of the adaptor body is configured to vertically position the optical fiber connector in a positioning plate.

In another embodiment, the connector part of the adaptor body comprises one or more connecting means to connect and align the optical fiber connector with a probe of the analytical device. In a preferred embodiment, the connector part of the adaptor body comprises at least two, preferably at least three connecting means to connect and align the optical fiber connector with the probe of the analytical device. In an even more preferred embodiment, the connector part comprises three connecting means to connect and align the optical fiber connector with the probe of the analytical device.

In another preferred embodiment, the one or more connecting means are positioned in a circular position in relation to each other, whereby they are configured to receive the probe of the analytical device in the middle of said circular positioning.

In another aspect, the present application discloses a combination of an optical fiber connector according to any of the embodiments described herein, and an optical fiber.

In still another aspect, a combination of an optical fiber connector according to any of the embodiments described herein, an optical fiber and a sealing cap is disclosed. Said sealing cap is positioned around the optical fiber, in particular said sealing cap is located around the optical fiber part that is not located in the optical fiber connector. When the optical fiber is placed in a recipient, the sealing cap ensures that the recipient is closed. In particular, the sealing cap is positioned just above the sensing zone of the optical fiber. By inserting the optical fiber in the well or vial comprising the sample, the sealing cap is pushed into it and slides upwards until the final insertion depth is attained. As such, the vial or well is now sealed to prevent evaporation of moisture or contamination of the environment. As such, the head space in the vial or well is minimized. After the analysis, when the optical fiber is retracted for disposal, the vial or well remains stuck to the optical fiber via the sealing cap, and as such the vial or well together with the optical fiber can be discarded as a whole with the vial or well remaining closed by the sealing cap. As is evident from this embodiment, the optical fiber connector according the invention not only enables a simple single step procedure in the positioning, alignment and fixation of the optical fiber with respect to the (bio)analytical device, but also with respect to the sample.

In a further aspect, the present application discloses a method for positioning and aligning an optical fiber into a bioanalytical device. Said method comprises the following steps: (1) positioning and aligning the optical fiber in the base component of the optical fiber connector according to any of the embodiments described herein; (2) mounting the mountable component of the optical fiber connector on the base component, to position, align and fix the optical fiber in the optical fiber connector (3) connecting the optical fiber connector comprising the optical fiber with the probe of a analytic device. In a further embodiment, a sealing cap is positioned around the optical fiber, in particular around the optical fiber part before the optical fiber is positioned and aligned in the base component of the optical fiber connector.

The present invention can further be disclosed using the following numbered embodiments:
1. An optical fiber connector for positioning and alignment of an optical fiber in (an optical unit of) an analytical device, said optical fiber connector comprising:
   an adaptor body comprising an opening to receive the optical fiber and a connector part being configured to be connected with a (bio-)analytical device; in particular with a probe, a biosensor mount or biosensor manifold of a (bio-)analytical device, and
   an optical fiber alignment body, comprising a base component and a mountable component;
   the base component comprising an alignment groove in its inner side, said optical fiber connector characterized in that:
      the adaptor body and the base component are single-pieced; and
      the mountable component and the base component are configured to cooperate in positioning, alignment and fixation of the optical fiber in the optical fiber connector, wherein the inner side of the base component and the inner side of the mountable component are oriented towards each other.
2. The optical fiber connector of embodiment 1 wherein the mountable component comprises one or more clamping means configured to cooperate with one or more recesses in the base component, and for fixation of the optical fiber in the optical fiber connector, in particular for fixation of the optical fiber in the optical fiber connector without a bonding component such as glue or an epoxy resin.
3. The optical fiber connector of embodiment 2 wherein the mountable component comprises two clamping means located on both longitudinal sides of the mountable component, in particular over the full central part of the mountable component.
4. The optical fiber connector of any of the preceding embodiments, wherein the base component comprises one or more guiding means; preferably at least two guiding means, to guide the mounting of the mountable component on the base component.
5. The optical fiber connector of embodiment 4, wherein the guiding means are located on each side of the alignment groove.
6. The optical fiber connector of any of the preceding embodiments wherein the mountable component comprises on its inner side one or more protrusions configured to position, align and fix the optical fiber in the alignment groove of the base component and in the opening of the adaptor body.
7. The optical fiber connector of embodiments wherein the mountable component comprises at least two protrusions.
8. The optical fiber connector of embodiment 6 or 7 wherein the protrusions are present in the center part of the inner side of the mountable component; in particular wherein the one or more protrusions are positioned over the full length of the center part of the inner side of the mountable component.
9. The optical fiber connector of any one of embodiments 6 to 8 wherein the one or more protrusions are present in the first and second end part of the inner side of the mountable component.
10. The optical fiber connector of any one of embodiments 6 to 9 wherein the one or more protrusions are configured so that they fit on the optical fiber when the mountable component is placed on the base component comprising the optical fiber.
11. The optical fiber connector of embodiment 10 wherein the one or more protrusions are hemispherical.
12. The optical fiber connector of embodiment 11 wherein one or more protrusions of the mountable component have a beveled surface

13. The optical fiber connector of any of the preceding embodiments wherein the mountable component comprises a longitudinal recess on its inner side to receive the optical fiber when the mountable component is placed on the base component comprising the optical fiber.
14. The optical fiber connector of embodiment 13 wherein longitudinal recess is present on the inner side of both end parts of the mountable component.
15. The optical fiber connector of embodiment 13 or 14 wherein the longitudinal recess comprises the one or more protrusions configured to position and align the optical fiber.
16. The optical fiber connector of any of the preceding embodiments wherein the adaptor body comprises a fiber receiving part comprising an opening to receive the optical fiber, a flange part and a connector part to connect the fiber connector with the probe of the bioanalytical device.
17. The optical fiber connector of embodiment 16, wherein the flange part of the adaptor body is configured to vertically position the optical fiber connector in a positioning plate.
18. The optical fiber connector of embodiment 16 or 17, wherein the connector part of the adaptor body comprises one or more connecting means to connect and to align the optical fiber connector with the (bio-)analytical device; preferably wherein the connector part of the adaptor body comprises at least three connecting means to connect and to align the optical fiber connector with the bioanalytical device; even more preferably wherein the connector part of the adaptor body comprises at least three connecting means to connect and to align the optical fiber connector with the probe, biosensor mount or biosensor manifold of a bioanalytical device.
19. The optical connector of embodiment 18 wherein the connecting means are positioned in a circular position to receive the (bio-)analytical device.
20. A combination of an optical fiber connector according to any of the preceding embodiments and an optical fiber.
21. A method for positioning and aligning an optical fiber into a bioanalytical device, said method comprising:
1) positioning and aligning the optical fiber in the base component of the optical fiber connector according to any of the embodiments 1 to 19;
2) mounting the mountable component as defined in any of the aforementioned embodiments on the base component of the optical fiber connector according to any of the embodiments 1 to 19;
3) connecting the optical fiber connector comprising the optical fiber with the (bio-)analytical device.
22. Use of an optical fiber connector according to any of the preceding embodiments for positioning and aligning of an optical fiber into a bioanalytical device.

### BRIEF DESCRIPTION OF THE DRAWINGS

FIG. 1: Optical fiber connector according to an embodiment of the invention.

FIG. 2: Part of the optical fiber connector according to an embodiment of the invention; in particular the optical fiber alignment body and the adaptor body are shown.

FIG. 3: An embodiment of the mountable component of the optical fiber connector according to the invention is shown, wherein the mountable component comprises on its inner side two protrusions (15) configured to position and align the optical fiber in the alignment groove of the base component and in the opening of the adaptor body, and to fix the optical fiber in the alignment groove of the optical fiber connector when mounted on the base component FIG. 4: Another embodiment of the mountable component of the optical fiber connector according to the invention is shown, wherein the mountable component comprises several protrusions (15) on its inner side configured to position and align the optical fiber in the alignment groove of the base component and in the opening of the adaptor body, and to fix the optical fiber in the alignment groove of the optical fiber connector when mounted on the base component.

FIG. 5: The mountable component according to an embodiment of the present invention, showing the clamping means (6) and two openings (10) to receive the guiding means of the base component (not shown).

FIG. 6: Side view of a mountable component according to an embodiment of the present invention.

FIG. 7: Side view showing an optical fiber connector according to an embodiment of the present invention and a optical fiber (17). The optical fiber connector comprises an adaptor body (1) and base component (2) that are single-pieced, and a mountable component (4) wherein the mountable component and base component are configured to cooperate in positioning, fixation and alignment of the optical fiber (17) such that the inner side of the base component and the inner side of the mountable component are oriented towards each other.

FIGS. 8 A and B shows different side views of a positioning plate (18) comprising several optical fiber connectors (1) according to the present invention and their corresponding optical fibers (17).

FIG. 9 shows an optical fiber connect or (1) according to an embodiment of the present invention and an optical fiber (17) comprising a sealing cap (19).

### DETAILED DESCRIPTION OF THE INVENTION

The present invention has the aim to provide an optical fiber connector that allows the correct positioning and aligning of an optical fiber in an (bio-)analytical device; in particular the correct positioning and aligning of an optical fiber onto the probe, the optical unit, the biosensor mount or the biosensor manifold of a (bio-)analytical device. The optical fiber connector of the present invention allows the optical fiber alignment and fixation without the use of glue, alignment corrections or polishing of the optical fiber ends. The connector of the present invention allows the optical fiber to be aligned perpendicular and central towards the optical unit of the analytical device. Furthermore, the presence of the mountable component ensures that the optical fiber is clamped (fixated) over a considerable length in the connector, and therefore also improves the alignment, fixation and positioning of the optical fiber in the connector.

Hereinafter, the present invention will be described based on preferred embodiments thereof with reference made to the drawings. Though, said drawings have no intention to be limiting the invention.

As already mentioned above, the optical fiber connector of the present invention comprises an adaptor body comprising an opening to receive the optical fiber and being configured to be connected with the optical unit of an analytical device, and an optical fiber alignment body comprising a base component and a mountable component wherein the base component comprises an alignment groove in its inner side. Said optical fiber connector is typically characterized in that the adaptor body and the base component are single-pieced. As a result, any misalignment between the adaptor body and base component is avoided. Furthermore, since the adaptor body and base component are single-pieced, connecting the optical fiber connector with the optical unit of the analytical device only needs one action, which also reduces the probability of any alignment artefacts. Furthermore, when the optical fiber is positioned in the base component, the mountable component is placed on top of the base component, thereby clamping the optical fiber in a fixed position, and hence also enhancing the correct alignment, fixation and positioning of the fiber into optical fiber connector. All in a single step without the need of a typical bonding process to fix the optical fiber in the connector or optical unit of an optical device.

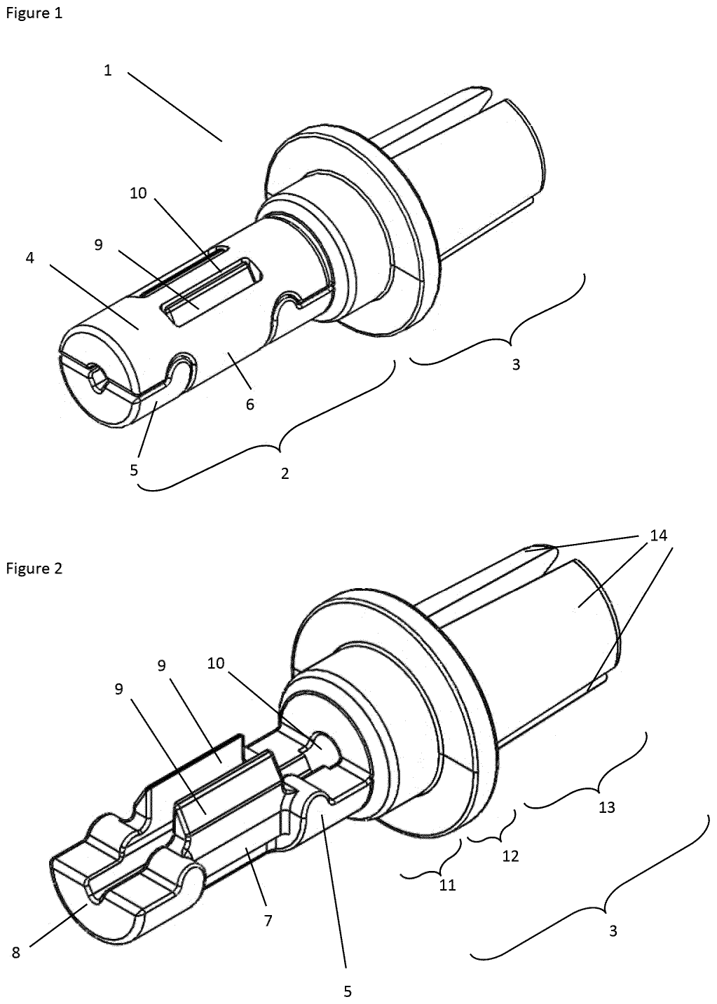

FIG. 1 shows an optical fiber connector (1) according to an embodiment of the present invention. In this figure, the adaptor body (3), the optical fiber alignment body (2) comprising a base component (5) and a mountable component (4) are shown. The mountable component (4) is fixed and clamped on the base component (4).

The optical fiber connector (2) is also characterized in that the mountable component (4) and the base component (5) are configured to cooperate in positioning, fixation and alignment of an optical fiber such that the inner side of the base component (5) and the inner side of the mountable component (4) are oriented towards each other. In FIG. 1 the optical fiber is not shown. By using a mountable component (4), the optical fiber can first be positioned in the base component (5), where after the mountable component (4) is mounted on said base component. This not only fixes the optical fiber in the base component, but also ensures a correct alignment and positioning of the optical fiber. Typical for the present invention is that once the mountable component (4) is mounted on the base component (4) it cannot be removed anymore without damaging the optical fiber connector. As a result, once the optical fiber is positioned and the mountable component is mounted on the base component, the optical fiber is fixed and cannot be removed anymore, which also ensures a correct alignment and positioning into the optical unit of the analytical device.

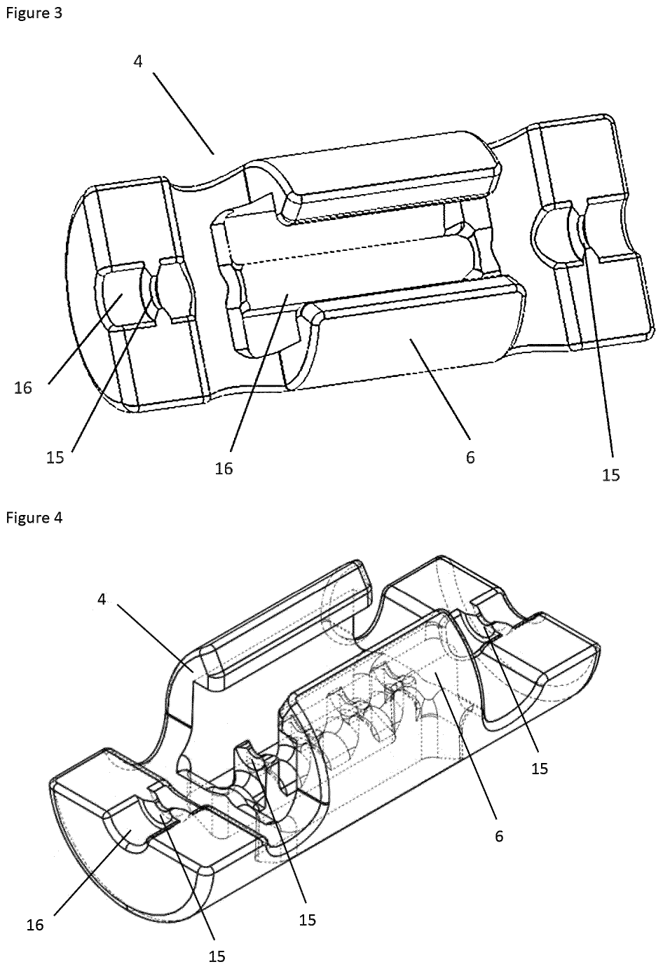

In a further aspect, the mountable component comprises one or more clamping means (6) configured to cooperate with one or more recesses (7) in the base component (5), as can be observed for example in FIGS. 1 and 2. Said clamping means (6) ensure that the mounting component (4) is mounted in a fixed and clamped way on the base component (5). The clamping means, together with the optical fiber alignment elements (alignment groove (8) and longitudinal recess (16)) in the mountable component (4) and the base component (5), will assure fixation of the optical fiber in the optical fiber connector according to the invention. In a particular embodiment, at least two clamping means; and preferably two clamping means, are present. Also preferably, said clamping means (6) are located on both longitudinal sides of the mountable component (4), and they are configured to cooperate with the recesses (7) present in the longitudinal side of the base component (5). By positioning the clamping means (6) on both longitudinal sides of the mountable component (4), the mountable component can be mounted in a balanced manner on the base component (5). As a result, the clamping and aligning forces are evenly distributed over the full length of the clamped optical fiber. Furthermore, the clamping means (6) are preferably located over the full central part of the mountable component (4), thereby ensuring that the mountable component (4) is positioned on an evenly distributed manner over the full length of the base component (5). In the mountable component (4) of FIG. 1, two clamping means (6) are present on each longitudinal side in the central part, wherein said clamping means (6) cooperate with two recesses (7) in each longitudinal side of the central part of the base component (5). As a result of these configurations wherein the clamping means longitudinally extend over at least the full central part of the mountable component, the clamping and aligning forces are evenly distributed over the full length of the clamped optical fiber. Such evenly distribution of the clamping and aligning forces prevents unwanted disturbance of the optical signal across the optical fiber.

A typical feature of the optical fiber connector is that the base component (5) and the adaptor body (3) are single-pieced. This can for example be observed in FIG. 2. FIG. 2 shows the optical fiber connector according to an embodiment, though without the presence of the mountable component. As can be observed from the drawing, the base component (5) and the adaptor body (3) are single-pieced, which facilitates the perfect alignment and positioning of the optical fiber. FIG. 2 further shows the presence of an optical fiber alignment groove (8) in the base component (5). The optical fiber alignment groove (8) facilitates matching (i.e., aligning) the optical fiber. There are no specific restrictions on the shape of the optical fiber alignment groove, and the optical fiber alignment groove can be of any shape that is able to receive the optical fiber. For example, the optical fiber alignment groove can be a U-groove, a semicircular groove, or a V-groove. In a preferred embodiment, said optical fiber alignment groove is a V-shaped groove or V-groove.

FIG. 2 also shows the presence of two guiding means (9) in the base component, each guiding means (9) being located on each side of the optical fiber alignment groove (8). As already indicated above, the base component (5) may comprise one or more guiding means (9). Said guiding means (9) will facilitate mounting of the mountable component in a correct position on the base component (5). In particular, the guiding means (9) will help to guide the clamping means of the mountable component to their corresponding recess (7) in the base component. In a particular embodiment, said guiding means (9) are raised edges on the inner side of the base component (5), located on each side of the optical fiber alignment groove, as shown in FIG. 2. Said guiding means (9) will facilitate opening of the clamping means of the mountable component once the mountable component is placed on the base component. Further, the guiding means (9) also assure proper orientation while mounting the optical fiber into the (bio-)analytical device.

In a further specific embodiment, the mountable component (4) may comprise one or more openings (10) to receive the guiding means (9) once the mountable component is positioned on top of the base component. For example, in FIG. 1, two openings (10) are present in the mountable component to receive the two guiding means (9) of the base component. These openings (10) equally assist in a proper positioning and foul proof assembly of an optical fiber in the optical fiber connector according to the invention.

FIG. 2 further shows the opening (20) to receive the optical fiber in the adaptor body; in particular in the fiber receiving section of the adaptor body.

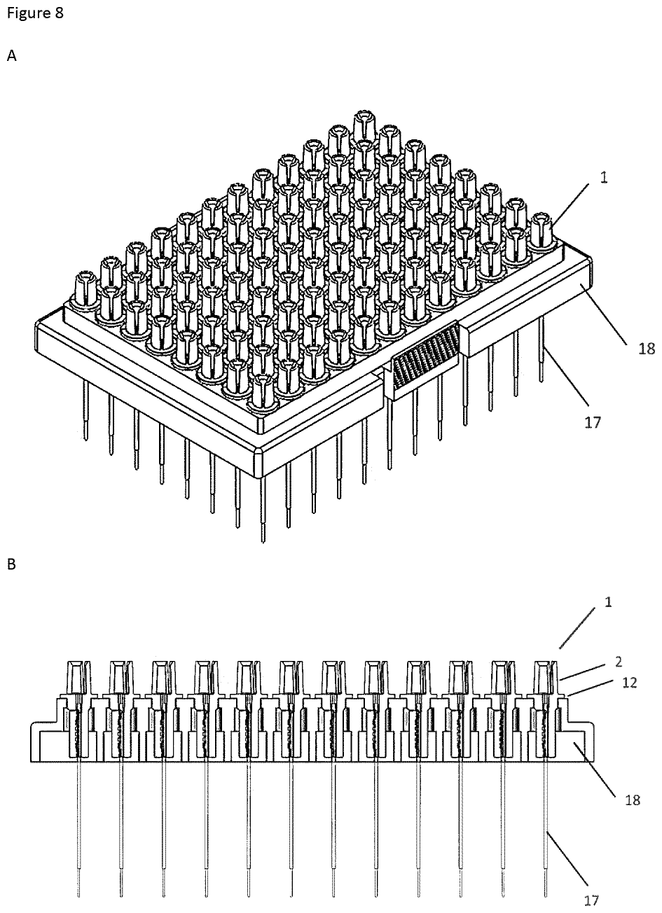

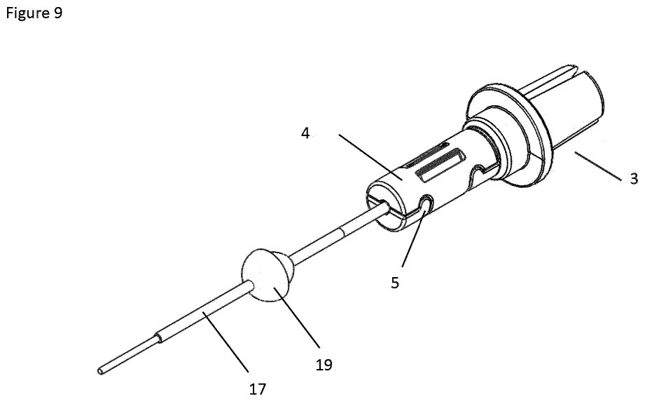

FIGS. 1 and 2 further show the adaptor body comprising a fiber receiving section (11), a flange part (12) and a connector part (13). The fiber receiving section (11) comprises an opening (20) to receive the optical fiber, whereas the flange part (12) ensures that the optical fiber connector can be correctly placed in a vertical direction into a positioning plate, for example as shown in FIGS. 8 and 9. The flange part (12) further ensures that the optical fiber connector is able to hang in an opening of such a positioning plate. Further the adaptor body (3) also comprises a connector part (13) to facilitate the connection with the (bio)analytical device. Said connector part comprises one or more connecting means to connect and align the optical fiber connector with a (bio)analytical device. In FIGS. 1 and 2, the connector part (13) comprises three connecting means (14) that are positioned in a circular orientation in relation to each other. In this way, the connecting means (14) are able to receive the probe of the (bio)analytical device in the middle of said circular positioning.

FIGS. 3, 4, 5 and 6 all show different embodiments of the mountable component (4) of the optical fiber connector of the present invention.

The mountable component (4) typically comprises one or more protrusions (15) on its inner side. Said protrusions (15) ensure that when the mountable component (4) is positioned on the base component comprising the optical fiber, the optical fiber is being firmly fixed onto the base component thereby also ensuring the correct positioning and alignment of the optical fiber in the optical fiber connector. Furthermore, by using a mountable component no glue or any other types of fixation means are needed.

The one or more protrusions (15) can be positioned in the central part or in both end parts of the inner side of the mountable component. In another embodiment, protrusions (15) can be positioned in both the central part and both end parts of the inner side of the mountable component.

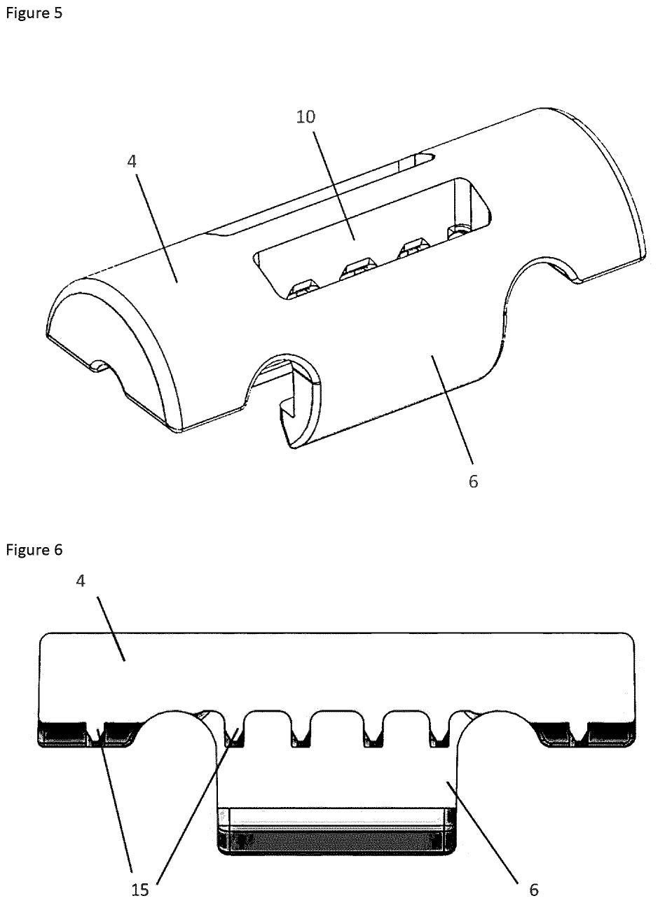

For example, FIG. 3 shows a mountable component (4) in which the protrusions (15) are only present in both end parts; in particular in said mountable component each end part comprises one protrusion. In the mountable component in FIG. 3, also the clamping means (6) are shown. FIG. 4, FIG. 5 and FIG. 6 show a mountable component comprising protrusions in both the central part and in both end parts of the inner side of the component. The presence of the protrusions (15) in the center part of inner side of the mountable component provides an evenly distributed pressure of the mountable component on the optical fiber. FIG. 4 further shows that the protrusions (15) are configured in such a way that they completely fit onto the optical fiber; in particular in this embodiment, the protrusions (15) are hemispherical. Further, and also shown in FIG. 4, the protrusions (15) may have a beveled surface.

Since the mountable component will be placed on the base component at the moment the optical fiber is present in the base component, said mountable component (4) further comprises a longitudinal recess (16) on its inner side to receive the optical fiber. Said longitudinal recess can be present over the full length of the inner side of the mountable component. In another embodiment, said longitudinal recess is at least present in both end parts of the mountable component. In another embodiment, the longitudinal recess comprises the one or more protrusions configured to position, fix and align the optical fiber. Thus, in one embodiment, and as shown in FIG. 4, 5 or 6, the mountable component comprises a longitudinal recess (16) on the inner side at both end parts wherein said longitudinal recess also comprises one or more protrusions (15).

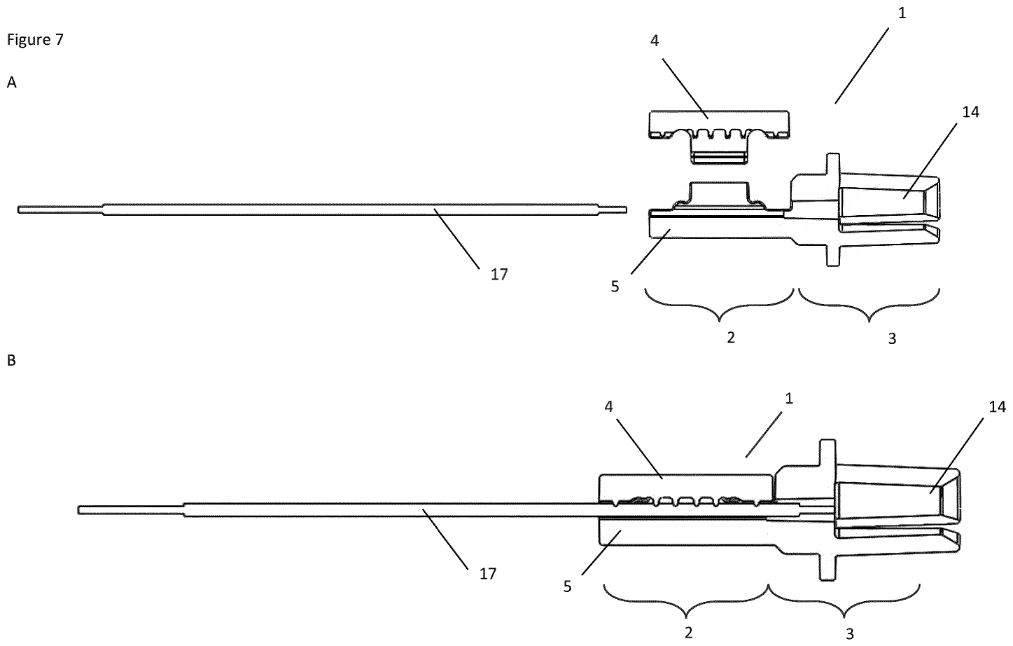

As already outlined above, the optical fiber connector of the present invention facilitates the correct positioning, fixation and alignment of an optical fiber into a (bio)analytical device. To this end, the optical fiber connector comprises an adaptor body (3) that is configured to receive a probe of the (bio)analytical device. The adaptor body (3) therefore comprises one or more connecting means (14); preferably at least two connecting means (14); even more preferably three connecting means (14), wherein said connecting means are positioned in such way that the adaptor body (3) can receive the probe of the analytical device. FIG. 7A-B shows an optical fiber connector (1) comprising three connecting means (14) positioned in a circular orientation in order to receive the analytical device, and an optical fiber (17). In particular, said connecting means are configured to receive the probe, optical unit, or biosensor mount or manifold of the (bio-)analytical device. Said connecting means may further comprise a tapered end which facilitates gliding and positioning of the probe into the adaptor body. Furthermore, the tapered ends of the connecting means also generate a clamping force such that the connecting means are firmly hold and aligned around the probe or manifold of the (bio-)analytical device. The present application further discloses a combination of an optical fiber connector according to any of the described embodiments and an optical fiber. Said combination also shown in FIGS. 7 A and B.

The optical fiber in all embodiments of the present invention can either be a naked optical fiber or a coated optical fiber or an optical fiber comprising a jacket. The naked optical fiber may be, for example, a quartz-based optical fiber. Moreover, the coating of the optical fiber can be a resin coating that is formed, for example, by substantially concentrically coating either one or a plurality of layers of a UV curable resin or polyamide resin or the like. In a preferred embodiment, a coated optical fiber is used. In a further preferred embodiment, the optical fiber is a multimode optical fiber. In a further specific embodiment, the optical fiber is a hard TECS-clad silica core multimode optical fiber.

In a specific embodiment, the optical fiber is an optical fiber used in fiber optic surface plasmon resonance (FO-SPR). SPR is a standard technology in biomolecular interaction analysis, and allows measuring the interaction of matter (typically biomolecules) to a surface coated with a bioreceptor without the use of a label. When used in FO-SPR, the optical fiber is coated with a metal having a real dielectric negative constant, such as gold or silver. Nevertheless, can also be used appropriate meta or nano materials having a real dielectric negative constant. In another preferred embodiment, and when used in FO-SPR the optical fiber is coated with bioreceptors; Optical fibers are a standard technology to guide light and allows remote sensing, continuous analysis and in situ monitoring of biomolecular interactions. For the fiber optic implementation, an SPR signal is generated by irradiating light into a custom-made optical fiber which serves as a fiber optic SPR sensor.

The analytical device to which the optical fiber and optical fiber connector will be connected can by any type of analytical device comprising a probe or biosensor manifold, or microfluidic analytical device. Microfluidic analytical devices are for example optical fiber refractometers in microchannels, optical fiber mediated immunoassays in microchannels, or optical fiber sensors using SPR. The analytical device is preferably a bio-analytical device for sensing analyte. In a specific embodiment, the bio-analytical device is a device that is connected to a fiber optic SPR sensor.

FIG. 7A-B further shows that after positioning of the optical fiber (17) into the base component (5) and the adaptor body (3), the mountable component (4) is placed on top of the base component (5), thereby correctly positioning, fixing and aligning the optical fiber.

The present application thus also discloses a method for positioning and aligning an optical fiber into a (bio-)analytical device. Said method comprises: (1) positioning and aligning the optical fiber in the base component of the optical fiber connector, (2) mounting the mountable component on the base component of the optical fiber connector, thereby fixing the optical fiber in the optical fiber connector, and (3) connecting the optical fiber connector comprising the optical fiber the (bio-)analytical device.

As can be observed in FIGS. 8 A and B, the optical fiber connector (1) comprising the optical fiber (17) will be positioned in a positioning plate (18) comprises multiple openings. Said holes are configured to receive the optical fiber connector (1) comprising the optical fiber (17). In particular, each optical fiber alignment body (2) of the optical fiber connector is positioned in each opening of the positioning plate, whereas the optical fiber connector stays hung up in the positioning plate by the presence of the flange part (12). After all, the diameter of said flange part needs to be larger than the diameter of the opening in the positioning plate. Even more, the diameter of opening of the positioning plate needs to be bigger than the connector to allow controlled tilting of the connector for automatic mounting to the instrument mount. The side of the connector towards the instrument mount (manifold) is therefore also slightly angled towards the center of the connector, in order to ensure a smooth automated mounting in case the probe(s) or mount(s) of the analytical device or instrument are not perfectly aligned with the optical fiber(s).

Further, the positioning plate and its openings are configured in such a way that the optical fiber connectors will always be positioned in a complete vertical direction once they are placed in the positioning plate.

In a further aspect of the application, a sealing cap (19) can be present on the optical fiber (17); in particular said sealing cap (19) is positioned on the optical fiber part that is not placed in the optical fiber connector (1) (FIG. 9). The presence of the sealing cap (19) prevents evaporation of the sample into which the optical fiber is placed. Such a sealing cap can for example be a rubber cap, which is mounted on the optical fiber before the fiber is mounted on the connector. By sealing of the sample with the sealing cap, a measurement can take place at higher temperature or for a more prolonged time. For example, if an amplification of DNA or RNA is to be performed, the sample can be removed by the robot without opening the vial and thus avoiding contamination of the environment or avoiding contamination of the sample by contaminants present in the environment. The sealing cap can be made of any material that is able to withstand a temperature range between −20° C. and +200° C.; in particular a temperature range between −20° C. and +130° C.; even more in particular a temperature range between −20° C. and +55° C. The material of the sealing cap should also be flexible such that it ensures a good sealing of the vial or well comprising the sample. Therefore, the sealing cap can be made of a thermoplastic elastomer (TPE) polymer. In another embodiment, the sealing cap is made of a special copolymer comprising ethyl vinyl acetate, that offers a high vapor barrier.

The optical fiber connector according to all the embodiments of the present invention can be made of any type of material that is strong enough to fix and align the optical fiber. In particular, said material should at least have one of the following characteristics: medical grade, resistant to gamma radiation, UV stable, relatively strong and stiff, and dimensionally stable.

1. An optical fiber connector for positioning and alignment of an optical fiber in a (bio-) analytical device, said optical fiber connector comprising:
an adaptor body (3) comprising an opening (20) to receive the optical fiber and a connector part (13) being configured to be connected with the (bio-)analytical device, and
an optical fiber alignment body (2), comprising a base component (5) and a mountable component (4); the base component comprising an optical fiber alignment groove (8) in its inner side,
said optical fiber connector wherein the adaptor body (3) and the base component (5) are single-pieced; and characterized in that;
the mountable component (4) and the base component (5) are configured to cooperate in positioning, alignment and fixation of the optical fiber such that the inner side of the base component and the inner side of the mountable component are oriented towards each other.

2. The optical fiber connector of claim 1 wherein the mountable component comprises one or more clamping means (6) configured to cooperate with one or more recesses (7) in the base component, and for fixation of the optical fiber in the optical fiber connector; in particular for fixation of the optical fiber in the optical fiber connector without a bounding component.

3. The optical fiber connector of claim 2 wherein the mountable component comprises two clamping means (6) located on both longitudinal sides of the mountable component; in particular over the full central part of the mountable component.

4. The optical fiber connector of any of the preceding claims, wherein the base component comprises one or more guiding means (9); preferably at least two guiding means, to guide the mounting of the mountable component on the base component; wherein the guiding means are located on each side of the optical fiber alignment groove.

5. The optical fiber connector of any of the preceding claims wherein the mountable component comprises on its inner side one or more protrusions (15) configured to position, align and fix the optical fiber in the alignment groove (8) of the base component and in the opening (20) of the adaptor body (3).

6. The optical fiber connector of claim 5 wherein the protrusions are present in the center part of the inner side of the mountable component; in particular wherein the one or more protrusions are positioned over the full length of the center part of the inner side of the mountable component.

7. The optical fiber connector of any one of claim 5 or 6 wherein the one or more protrusions are present in the first and second end part of the inner side of the mountable component.

8. The optical fiber connector of any one of claims 5 to 7 wherein the one or more protrusions are hemispherical and have a beveled surface.

9. The optical fiber connector of any of the preceding claims wherein the mountable component comprises a longitudinal recess (16) on its inner side to receive the optical fiber when the mountable component is placed on the base component comprising the optical fiber; preferably wherein the longitudinal recess (16) is present on the inner side of both end parts of the mountable component.

10. The optical fiber connector according to claim 9, wherein the longitudinal recess (16) comprises the one of more protrusions according to any one of claims 5 to 9.

11. The optical fiber connector of any of the preceding claims wherein the adaptor body comprises a fiber receiving part (11) comprising an opening (20) to receive the optical fiber, a flange part (12) and a connector part (13) to connect the fiber connector with the probe of the bioanalytical device.

12. The optical fiber connector of claim 11, wherein the connector part of the adaptor body comprises one or more connecting means (14) to connect and to align the optical fiber connector with the (bio-)analytical device; preferably wherein the connector part of the adaptor body comprises at least three connecting means to connect and to align the optical fiber connector with the (bio-)analytical device.

13. A combination of an optical fiber connector according to any of the preceding claims and an optical fiber.

14. A method for positioning, aligning and fixation of an optical fiber into a bioanalytical device, said method comprising:
1) positioning and aligning the optical fiber in the base component of the optical fiber connector according to any of the claims 1 to 12;
2) mounting the mountable component on the base component of the optical fiber connector according to any of the claims 1 to 12;
3) connecting the optical fiber connector comprising the optical fiber with the (bio-)analytical device.

15. Use of an optical fiber connector according to any of the preceding claims for positioning, aligning and fixation of an optical fiber into a bioanalytical device.
